(19) United States
(12) Patent Application Publication
(10) Pub. No.: US 2022/0048434 A1
(43) Pub. Date: Feb. 17, 2022

(54) HITCH STEP AND METHOD OF MANUFACTURING

(71) Applicants: Robert E. Klein, Gresham, OR (US); Steven L. Mixon, Estacada, OR (US); Justin C. Burris, Oregon City, OR (US)

(72) Inventors: Robert E. Klein, Gresham, OR (US); Steven L. Mixon, Estacada, OR (US); Justin C. Burris, Oregon City, OR (US)

(21) Appl. No.: 16/992,287

(22) Filed: Aug. 13, 2020

(51) Int. Cl. B60R 3/00

(52) U.S. Cl. CPC B60R 3/007; B60D 1/58

(57) ABSTRACT

The present invention relates to a hitch step that may be secured to a vehicle in a hitch receiver, and a method of manufacturing the same, that overcomes the disadvantages of the prior art. The present invention provides a multi-step pressurization method that produces a strong, compact hitch step that is cost effect to manufacture.

### TECHNICAL FIELD

The present invention relates to a method of manufacturing a hitch step apparatus that may be installed in a hitch receiver of a vehicle. The inventive method includes a multi-step pressurization process which results in a hitch step having high strength, low warpage and reduced air pockets when compared to parts manufactured by prior art manufacturing processes.

### BACKGROUND OF THE INVENTION

The present invention is particularly intended for use on commercial vehicles, which may include a step for the vehicle operator to step up into the vehicle cab or to step up onto the side of the vehicle to secure a load or check the engine, for example. Prior art steps are large devices having intricate framing to support the weight of a vehicle operator without deforming. Accordingly, there is a need for a method of manufacturing a streamlined device that supports the weight of a vehicle operator.

### SUMMARY OF THE INVENTION

The present invention provides a hitch step that may be secured to a vehicle in a hitch receiver, and a method of manufacturing the same, that overcomes the disadvantages of the prior art. The present invention provides a multi-step pressurization method that produces a strong, compact hitch step that is cost effect to manufacture.

### BRIEF DESCRIPTION OF THE DRAWINGS

FIG. 1 is an isometric view of one example embodiment of a hitch step of the present invention.

FIG. 2 is a top view of the hitch step of FIG. 1.

FIG. 3 is a bottom view of the hitch step of FIG. 1.

FIG. 4 is a side view of the hitch step of FIG. 1.

FIG. 5 is an isometric view of another example embodiment of a hitch step of the present invention.

FIG. 6 is a top view of the hitch step of FIG. 5.

FIG. 7 is a bottom view of the hitch step of FIG. 5.

FIG. 8 is a side view of the hitch step of FIG. 5.

FIG. 9 is a schematic view of machinery to carry out the manufacturing process.

FIG. 10 is detailed schematic view of the machinery to carry out the manufacturing process.

### DETAILED DESCRIPTION OF THE PREFERRED EMBODIMENTS

The hitch step of the present invention, in one preferred embodiment, is a solid one piece Aluminum die cast step sized to be secured in a two inch receiver that is installed on many types of today's vehicles. The inventive hitch step is designed to be easily and releasably plugged into the receiver socket of the hitch receiver on a vehicle. The hitch step can be extended or retracted in different positions with respect to the hitch receiver. The tread pattern is designed so as to be easy to clean up and to provide a gripping texture. The hitch step is reinforced to handle a two-to-one weight safety factor. The hitch step is designed with smooth corners. The hitch step can be manufactured as cast or may be finished in a variety of different finishes. The hitch step can be made from several different Alloy combinations of Aluminum or other durable materials as may be desired. The inventive hitch step and the die casting process is described below.

FIG. 1 is an isometric view of one example embodiment of a hitch step 10 of the present invention. Hitch step 10 includes a bar 12 secured to a platform 14. Bar 12 may include a tongue region 16 sized to be received in a hitch receiver opening 18 installed on a vehicle. In one embodiment tongue region 16 may define a two inch by two inch square profile that is received in a mating two inch by two inch opening 18 of a hitch receiver. In other embodiments tongue region 16 may be sized and shaped in other designs as may be desired to particular hitch receiver. Tongue region 16 may include a plurality of apertures 20 sized to receive a hitch pin there through that may secure hitch step 10 on hitch receiver opening 18. The plurality of apertures 20 may be spaced along a length 22 of hitch step 10 so that the hitch step 10 may extend from hitch receiving opening 18 a desired distance. Hitch step tongue region 16 may include a transition region 24 that may extend downwardly, as shown, or upwardly, so that platform 14 is positioned lower, or higher, than bar 12. Platform 14 comprises a step that may include gripping structure 26 on a top surface 28, such as grooves that form treads. Platform 14 may further include strengthening structures 30 on an underside 32 of platform 14 wherein structures 30 give hitch step 10 the strength to support a vehicle operator's weight when the operator steps on platform 14. Strengthening structures 30 may extend along underside 32 of platform 14 and along bar 12.

FIG. 2 is a top view of the hitch step 10 of FIG. 1.

FIG. 3 is a bottom view of the hitch step 10 of FIG. 1.

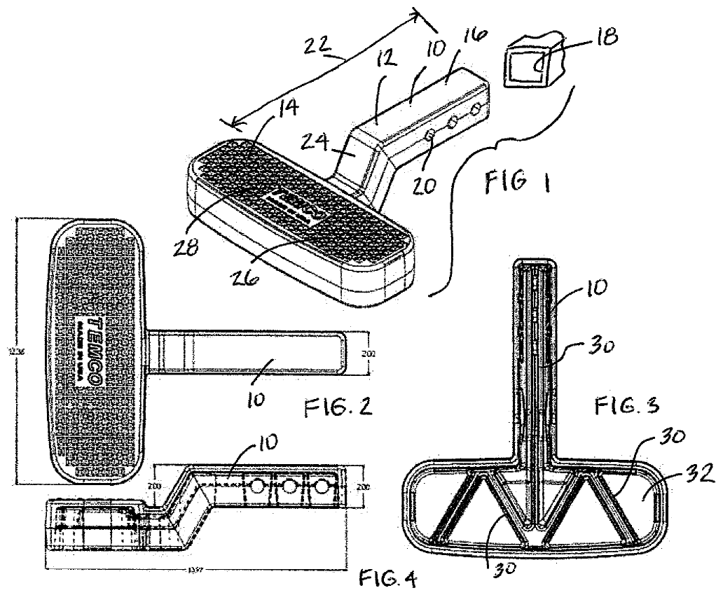

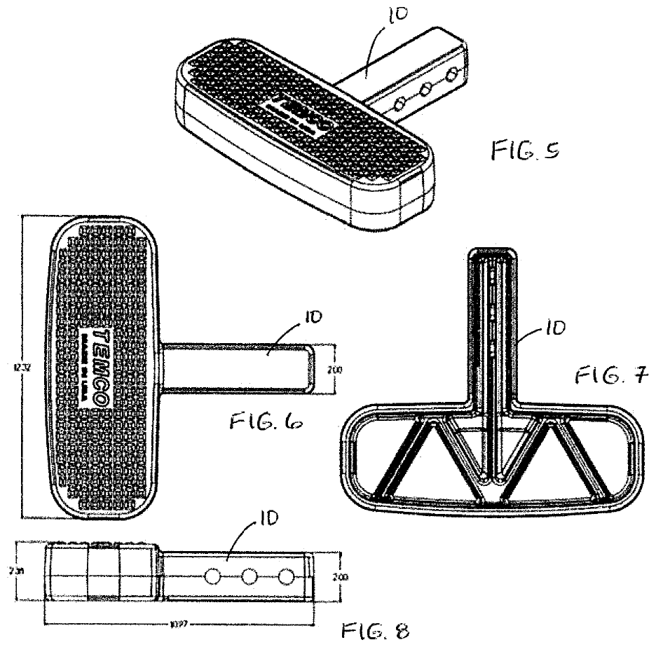

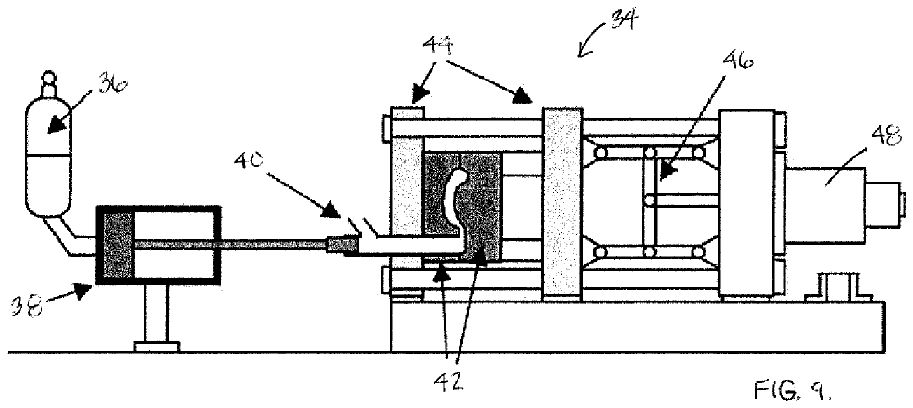

FIG. 4 is a side view of the hitch step 10 of FIG. 1.

FIG. 5 is an isometric view of another example embodiment of a hitch step 10 of the present invention. In this embodiment, bar 12 is straight and does not include a transition region 24 of FIG. 1.

FIG. 6 is a top view of the hitch step 10 of FIG. 5.

FIG. 7 is a bottom view of the hitch step 10 of FIG. 5.

FIG. 8 is a side view of the hitch step 10 of FIG. 5.

FIG. 9 is a schematic view of machinery to carry out the manufacturing process. The process of manufacturing the hitch step of the present invention may involve use of a manufacturing assembly 34 that may include an accumulator 36, a piston 38, a molten dosing system assembly 40, a die 42 assembly, a platen 44, a toggle clamp 46, and a motor 48.

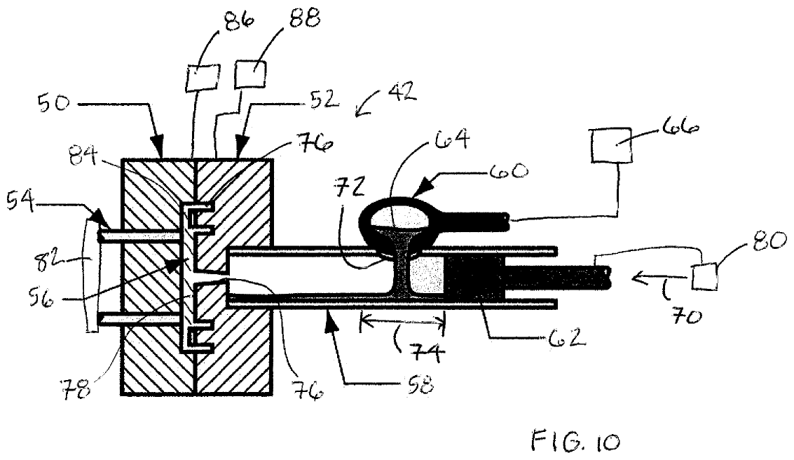

FIG. 10 is detailed schematic view of the machinery of the manufacturing process, and more specifically a detailed view of the die assembly 42. Die assembly 42, in the embodiment of the schematic shown, includes a movable die half 50, a fixed die half 52, ejector pins 54, a cavity 56, a shot chamber 58, a ladle 60 and a ram or piston 62.

One preferred embodiment of the present invention includes a die casting process which may include an aluminum melting phase, a die cast injection phase, a solidification phase and a part removal phase. In particular, a cold chamber die cast injection phase includes a casting shot profile that is comprised of multiple phases. When metal is transferred from the crucible to the machine, it is delivered by a ladling system and poured into a cylindrical shot sleeve. In the typical die casting process, that sleeve is only partially filled with metal, in our case aluminum. In order to get the material from the sleeve into the cavity, it is pushed by a plunger 62. The plunger's position relative to time and the pressure it applies on the metal are what defines its shot profile. The first phase of the shot profile is the slow shot. The purpose of this phase is to begin moving the molten metal toward the die cavity at a slow enough velocity so as to not spit molten metal out of the pour hole that it was delivered into. The next phase of the profile is the intermediate shot. The purpose of this phase is to force the entrapped air in the shot sleeve out by filling it with the molten aluminum. This phase takes place at a set velocity so as to develop a wave front that does not entrap any excessive air in the metal. The next phase is the fast shot. During this phase, the metal is accelerated to a much higher velocity and delivered into the cavity. The high velocity is used to fill the cavity quickly before the metal solidifies. Once the fast shot phase is complete, the plunger comes to a near stop and the intensification phase begins. During this phase, the cavity is full so high pressure is applied to the metal instead of the force of the piston moving at a high velocity. This high metal pressure serves to compensate for shrinkage porosity that inherently develops as the casting is solidified. These settings are controlled with a human machine interface (HMI) on the die cast machine panel box and are generally left alone once the machine is in steady state and making quality parts. The present invention may also integrate extra features into the shot profile such as a deceleration phase. The die casting method should be designed around what machines are available and their features. Since every die casting job is different, there are no specific quantities that apply across the board. Pressures, velocities, etc. may vary for different types of parts and materials used, and there may be a range of acceptable values depending on customer demands and many other variables. The process will now be described in more detail. However, Applicant has found that including four phases within the injection phase will result in manufactured parts having properties superior to parts manufactured by prior art methods.

### Aluminum Melting Phase

The die casting method of the present invention involves heating a material, such as aluminum, well into its liquid phase for injection. The melting point of aluminum is specifically dependent on its alloy, but generally the full liquid phase is met at above 1,100 degrees Fahrenheit. In the present invention, the aluminum temperature is generally taken several hundred degrees higher than this to assure that alloy chemistry is maintained. The aluminum is melted in furnaces using ingots purchased from qualified suppliers and may also include re-melt excess material from the casting process. Once melted and taken up to the desired temperature, the aluminum is ready to be injected into the mold.

### Die Cast Injection Phase

When a die cast machine is ready for its next cycle, i.e., when the die halves 50 and 52 are closed, secured together, and ready for shot, an automated ladle 60 removes a prescribed volume of molten material 64, such as molten aluminum 64, from a holding furnace 66 and pours it into the shot sleeve or chamber 58. Once pouring is complete, the injection phase begins.

The first injection phase is the slow shot phase where the shot plunger or ram 62 moves forward in a direction 70 at a low speed to begin pushing air out of the sleeve 68 and to move past the pour hole 72 in the sleeve. After a prescribed distance 74, such as past pour hole 72 in shot sleeve 68, depending on process set up, the plunger 62 enters an intermediate speed phase where the speed is increased to fill the runner system 76 with aluminum. Once this is complete, the machine enters a fast shot phase where velocity is greatly increased to fill the part cavity 78 with aluminum. After the part cavity 78 is filled and the plunger 62 has stopped moving, the hydraulic cylinder 80 pushing the plunger 62 is pressurized to a higher pressure. This intensification or squeeze phase takes the aluminum pressure within the die 42 to over 10,000 psi to ensure proper fill and to minimize aluminum shrinkage problems.

### Solidification Phase

The die cast machine 34 continues to hold the die halves 50 and 52 together at its rated tonnage during the solidification phase. The die cast dies are water or oil cooled to remove heat from the molten material, such as aluminum, during solidification. After a prescribed amount of time, where the resulting casting, i.e., the solidified material in the die, has sufficiently solidified and cooled, the die opens the ejector or moving half 50 of the die 42.

### Part Removal Phase

Once the machine is fully open, the die cast ejection is triggered. Die cast dies 42 have ejector pins 54 that extend through the part cavity 78. These pins 54 are mounted in an ejector plate 82 on the back of the die cast tool. Once ejection has moved fully forward, the casting 84 is removed by an operator or an automated machine or robot 86. The casting 84 is cooled to a temperature suitable for subsequent operations. This cooling can be achieved with a cooling device 88 such as a fan driven air cooling device or the unfinished cast part 84 can be water quenched. Quenching reduces casting temperature more rapidly, but the process must be controlled to prevent part distortion.

In one preferred method the total length the piston will travel in direction 70 is in a range of 10 to 20 inches, and in a preferred method is approximately 16 ¾ inches. The timing of the entire piston movement phase is in a range of 10 to 60 seconds, and in a preferred method is approximately 15 seconds. The shot pressure, which is how much pressure the molten material is subjected to during the intensification phase, is in a range of 1000 PSI to 1500 PSI, and in a preferred method, is 1200 PSI. The temperature of the molten aluminum is in a range of 1100 to 1500 degrees Fahrenheit, and in a preferred method is approximately 1275 degrees Fahrenheit. The cooling process may be in a range of 3 to 10 minutes, and in a preferred method is approximately 5 minutes after the part is pulled from the mold.

In a preferred embodiment utilizing aluminum to cast a part, during the first, or slow, shot phase the piston 62 will move in direction 70 at a speed in a range of 0.1 to 3 inches per second, and in one embodiment, will move at approximately 1 inch per second. During the second, or fast, shot phase the piston 62 will move in direction 70 at a speed in a range of 5 to 20 inches per second, and in one embodiment, will move at approximately 11 inches per second. During the third, or start of impact, phase the piston 62 will move in direction 70 at a speed in a range of 15 to 25 inches per second, and in one embodiment, will move at approximately 18 inches per second. During the fourth, or intensification, phase the piston 62 will move at a speed in a range of 10 to 20 inches per second, and in one embodiment, will move at approximately 16 inches per second.

As may be understood from the above description and drawings, the present invention has many advantages over prior art hitch steps and manufacturing processes. In the above description numerous details have been set forth in order to provide a more through understanding of the present invention. It will be obvious, however, to one skilled in the art that the present invention may be practiced using other equivalent designs and method steps.

I claim:

1. A method of manufacturing a hitch step, comprising:
a first injection phase wherein a plunger moves forward at a first speed to push air out of a shot sleeve and to move past a pour hole in said shot sleeve;
a second injection phase wherein said plunger moves forward at a second speed to fill a runner system with molten material, wherein said second speed is faster than said first speed; and
a third injection phase wherein said plunger moves forward at a third speed to fill a part cavity with said molten material, wherein said third speed is faster than said second speed.

2. The method of claim 1 further comprising a pressurization phase after said third injection phase, wherein during said pressurization phase said plunger is pressurized so as to bring said molten material to a pressure of at least one thousand pounds per square inch.

3. The method of claim 2 further comprising a solidification phase wherein a die holding said molten material is cooled during solidification of said molten material contained within said die.

4. The method of claim 3 wherein said molten material that is solidifying is held at a pressure of at least one thousand pounds per square inch during said solidification phase.

5. The method of claim 3 wherein said solidification phase results in said molten material solidifying into a solid part.

6. The method of claim 5 wherein solid part is ejected from said die by ejector pins.

7. The method of claim 6 further comprising a cooling phase wherein said ejected solid part is further cooled.

8. The method of claim 1 further comprising a melting phase that takes place before said first injection phase, wherein a solid material is melted to form said molten material, and wherein said molten material is heated to a temperature of at least eleven hundred degrees Fahrenheit.

9. A method of manufacturing a hitch step, comprising:
a first injection step wherein a plunger moves at a first speed to push air out of a shot sleeve, to move past a pour hole in said shot sleeve and to move molten material toward a die;
a second injection step wherein said plunger moves at a second speed to fill a runner system with said molten material, wherein said second speed is faster than said first speed; and
a third injection step wherein said plunger moves at a third speed to fill a part cavity within said die with said molten material, wherein said third speed is faster than said second speed.

10. The method of claim 9 further comprising a pressurization step after said third injection step, wherein during said pressurization step said plunger is pressurized so as to bring said molten material to a pressure of at least ten thousand pounds per square inch.

11. The method of claim 9 further comprising a solidification step wherein said die holding said molten material is cooled during solidification of said molten material contained within said die.

12. The method of claim 10 wherein said molten material that is solidifying is held at a pressure of at least one thousand pounds per square inch during said solidification step.

13. The method of claim 12 wherein said solidification step results in said molten material solidifying into a solid part.

14. The method of claim 13 wherein solid part is ejected from said die by ejector pins.

15. The method of claim 14 further comprising a cooling step wherein said ejected solid part is further cooled.

16. The method of claim 9 further comprising a melting step that takes place before said first injection step, wherein a solid material is melted to form said molten material, and wherein said molten material is heated to a temperature of at least eleven hundred degrees Fahrenheit.

17. The method of claim 9 wherein said molten material comprises an aluminum alloy, and wherein during said first injection step said plunger moves at said first speed in a range of 0.1 to 3 inches per second, during said second injection step said plunger moves at said second speed in a range of 5 to 20 inches per second, and during said third injection step said plunger moves at a third speed in a range of 15 to 25 inches per second.

18. A method of manufacturing a cast part, comprising:
a first injection step wherein a plunger moves at a first speed to push air out of a shot sleeve, to move past a pour hole in said shot sleeve and to move molten material toward a die;
a second injection step wherein said plunger moves at a second speed to fill a runner system with said molten material, wherein said second speed is faster than said first speed; and
a third injection step wherein said plunger moves at a third speed to fill a part cavity within said die with said molten material, wherein said third speed is faster than said second speed.

19. The method of claim 18 further comprising:
a pressurization step after said third injection step, wherein during said pressurization step said plunger is pressurized so as to bring said molten material to a pressure of at least ten thousand pounds per square inch; and
a solidification step wherein said die holding said molten material is cooled during solidification of said molten material contained within said die, wherein said molten material that is solidifying is held at a pressure of at least ten thousand pounds per square inch during said solidification step, wherein said solidification step results in said molten material solidifying into a solid part.

20. The method of claim 19 further comprising a melting step that takes place before said first injection step, wherein a solid material is melted to form said molten material, and wherein said molten material is heated to a temperature of at least eleven hundred degrees Fahrenheit, wherein said molten material comprises an aluminum alloy.
